(19) United States
(12) Patent Application Publication
(10) Pub. No.: US 2025/0165807 A1
(43) Pub. Date: May 22, 2025

(54) METHODS AND SYSTEMS FOR OPTIMIZATION PROBLEM TRANSFORMATION FOR FACILITATED RESOLUTION

(71) Applicant: ENTROPICA LABS, Singapore (SG)

(72) Inventors: Adrien VANDENBROUCQUE, Singapore (SG); Ewan Franek MUNRO

(21) Appl. No.: 18/730,663

(22) PCT Filed: Jan. 19, 2023
(86) PCT No.: PCT/SG2023/050037

§ 371 Date: Jul. 19, 2024

(30) Foreign Application Priority Data
Jan. 19, 2022 (SG) 10202200507Y

(51) Int. Cl. G06N 5/01

(52) U.S. Cl. CPC G06N 5/01

(57) ABSTRACT

Methods and system for transformation of an optimization problems to facilitate its resolution are provided. According to at least one aspect of the present embodiments, a method includes casting the optimization problem into a quadratic unconstrained binary model and transforming the optimization problem into an optimization problem in the same model but with reduced connectivity. Transforming the optimization problem into the optimization problem with reduced connectivity includes partitioning decision variables in the quadratic unconstrained binary model into two or more groups, each of the two or more groups comprising at least one decision variable node and introducing a register variable node between adjacent pairs of the at least one decision variable node in the two or more groups to hold partial values of a sum in a linear constraint to form the optimization problem with reduced connectivity.

### TECHNICAL FIELD

The present invention generally relates to computer-implemented optimization, and more particularly relates to methods and systems for optimization problems transformation for facilitated resolution.

### BACKGROUND OF THE DISCLOSURE

Mathematical optimization problems arise in many fields and disciplines, including chemistry, logistics, and machine learning. In many cases, such problems can be mapped onto (i.e., represented as an instance of) Ising spin systems or quadratic unconstrained binary optimization (QUBO) problems.

A possible angle to tackle such optimization problems is to make use of Monte-Carlo algorithms, like the Metropolis-Hastings algorithm or simulated annealing, which allow one to sample from the space of all possible solutions and potentially find or get close to the best configuration(s) of variables. One issue with such methods is that the samples they produce are often correlated due to the locality of transitions considered when exploring the space, giving only the chance to visit a small part of the entire space of solutions.

To circumvent this issue, one can turn to cluster Monte-Carlo algorithms to allow non-local configurations updates and potentially improve exploration. One cluster Monte-Carlo method of interest that has been studied recently is the Houdayer algorithm. This Monte-Carlo move and its derivatives, exhibit the interesting property that they are able to perform isoenergetic moves, i.e., moves that preserve the total energy of the configurations given as input.

Although it is useful in many situations, in practice the Houdayer move and its derivatives have the downside that, to be successful, they require the QUBO formulation of the optimization problem to be such that the number of pairwise interactions between variables is small. Equivalently, the graph underlying the problem should not be too connected.

Thus, there is a need to provide a method and system for transforming an optimization problem in order to facilitate its resolution and provide a higher chance of successful optimization by, for example, enabling the use of the Houdayer move. Furthermore, other desirable features will become apparent from the subsequent detailed description and the appended claims, taken in conjunction with the accompanying drawings and this background of the disclosure.

### SUMMARY

According to at least one aspect of the present embodiments, a method for transformation of an optimization problem to facilitate its resolution is provided. The method includes casting the optimization problem into a quadratic unconstrained binary model and transforming the optimization problem into an optimization problem having the same quadratic unconstrained binary model with reduced connectivity.

Transforming the optimization problem into the reduced connectivity optimization problem includes partitioning decision variables in the quadratic unconstrained binary model into one or more groups, each of the one or more groups comprising more than one decision variable node and introducing a register variable node between adjacent pairs of the more than one decision variable node in the one or more groups to hold partial values of a sum in a linear constraint to form the optimization problem with reduced connectivity.

According to another aspect of the present embodiments, a system for transformation of an optimization problem to facilitate its resolution is provided. The system includes one or more processors and a storage means comprising instructions for controlling the one or more processors. The instructions include instructions for controlling the one or more processors to cast the optimization problem into a quadratic unconstrained binary model and transform the optimization problem into an optimization problem having the quadratic unconstrained binary model with reduced connectivity. The instructions to transform the optimization problem into an optimization problem with reduced connectivity include instructions to partition decision variables in the quadratic unconstrained binary model into two or more groups, each of the two or more groups comprising at least one decision variable node and instructions to introduce a register variable node between adjacent pairs of the at least one decision variable node in the two or more groups to hold partial values of a sum in a linear constraint to form the optimization problem with reduced connectivity.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts an illustration of a conventional 2 by 3 Ising lattice of spins.

FIG. 2 depicts a flowchart of reducing connectivity for problem optimization in accordance with the present embodiments.

FIG. 3 depicts an illustration of introducing register variables between decision variables in accordance with present embodiments.

FIG. 4 depicts an illustration of a further topology of register variables and decision variables in accordance with the present embodiments.

FIG. 5 depicts an illustration of an exemplary resulting formulation after applying ReduCon in accordance with the present embodiments.

FIG. 6 depicts a graph of densities versus Houdayer success rates when using methods for all possible groupings with six variables in accordance with the present embodiments in an example where coefficients in the linear constraint are all equal.

FIG. 7 depicts a graph of densities versus Houdayer success rates when using methods for all possible groupings with six variables in accordance with the present embodiments in an example where coefficients in the linear constraint are different.

FIG. 8 depicts an illustration of the Houdayer move in a two-dimensional lattice in accordance with the present embodiments.

FIG. 9, comprising FIGS. 9A to 9C, depicts an exemplary illustration of a register forming a barrier and allowing creation of more than one connected component in a local overlap in accordance with the present embodiments, wherein FIG. 9A depicts a first configuration, FIG. 9B depicts a second configuration, and FIG. 9C depicts the local overlap of the first and second configurations.

FIG. 10 depicts an illustration of an exemplary resulting graph after applying ReduCon in accordance with the present embodiments where each group is formed by a single variable.

FIG. 11 depicts an illustration of an exemplary resulting graph after applying ReduCon in accordance with the present embodiments and the last register is removed.

FIG. 12 depicts a diagram of steps of a Houdayer move when using methods in accordance with the present embodiments.

And FIG. 13 depicts a graph of mean relative error together with standard deviation plotted as a function of iteration number for multiple aggregated parallel tempering procedures for different types of Monte-Carlo moves in accordance with the present embodiments.

Skilled artisans will appreciate that elements in the figures are illustrated for simplicity and clarity and have not necessarily been depicted in full detail.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of present embodiments to provide systems and methods for transforming optimization problems that can be formulated as Ising models or Quadratic Unconstrained Binary Optimization (QUBO) models into an equivalent formulation that allows a successful use of the Houdayer algorithm. Thus, in accordance with present embodiments, general optimization problems comprised of a quadratic objective function of binary variables together with linear equality constraints involving these variables are considered, as they can be easily cast into an Ising/QUBO formulation by turning linear constraints into quadratic penalties. In particular, the systems and methods in accordance with the present embodiments provide optimization solutions even for problems whose Ising/QUBO formulations have interactions between every pair of variables, the transformation reducing connectivity in the formulation by introducing new binary variables which allow rewriting quadratic penalties in a different manner, where “connectivity” refers to the structure of interactions in the Ising/QUBO formulation. To achieve this, the variables in the problem are partitioned into multiple groups which allow one to break down the computation of each sum involved in each linear constraint by saving intermediate values of those sums into registers. Thus, new binary variables that act as registers are introduced in order to hold partial values of intermediate sums in a linear constraint. With this augmented set of variables, the original constraints can be rewritten accordingly to make use of the new variables acting as registers, hence leading to a new Ising/QUBO formulation with a reduced connectivity overall. An advantage of considering problems in the form a quadratic objective function with linear constraints is that they encompass a large number of optimization problems such as Traveling Salesman problems, Maximum Cut problems, Number Partitioning problems, Knapsack problems, Minimum Vertex Cover problems and Graph Colouring problems.

Further, the following definitions, notation and conventions are used. When considering an optimization problem, a “state” is used to refer to any configuration of the underlying variables in a general sense (not necessarily in the context of an optimizer). For instance, a “state space” is referred to independently of any optimization procedure within it. In addition, a “configuration” is any combination of the underlying problem variables that might be visited during exploration of the state space by an optimizer and a “solution” is the final configuration returned by the optimizer, i.e., returned once the optimizer termination criteria have been satisfied. For an optimization problem with n binary variables (which take value in {0,1}), variables are represented with xᵢ, where i=1, 2, . . . , n. When collecting all variables into a vector, the resulting object is denoted as x∈{0, 1}ⁿ. And for an optimization problem with n spin variables (which take value in {−1,1}), variables are represented with σᵢ, where i=1, 2, . . . , n. When collecting all variables into a vector, the resulting object is denoted as σ∈{−1, 1}ⁿ.

The methods and systems in accordance with the present embodiments are particularly applicable to optimization problems which can be mapped onto a constrained optimization of the form

$$minimize {\sum }_{i = 1}^{n} {\sum }_{j = 1}^{n} {Q}_{ij} {x}_{i} {x}_{j} \qquad ( 1 )$$

$$subject to {\sum }_{i = 1}^{n} {b}_{1 i} {x}_{i} = {b}_{1}$$

$$⋮$$

$${\sum }_{i = 1}^{n} {b}_{mi} {x}_{i} = {b}_{m}$$

$${x}_{i} ∈ \{ 0 , 1 \} ∀ i ∈ \{ 1 , … , n \} ,$$

namely a quadratic objective function with m linear equality constraints, and n binary variables x₁, . . . , xₙ. In fact, it is shown hereinafter that advantageously linear inequality constraints can also be taken into account. The variables xᵢ of the original problem are referred to as “decision variables”. In addition, for simplicity in the discussion of the methods and systems in accordance with the present embodiments hereinafter, the case with m=1 linear constraint is mainly treated, but those skilled artisans will realize that the schemes discussed hereinafter can be generalized to quadratic objective functions with any number m linear constraints. While a technique to handle the general case of real numbers is discussed hereinafter, for simplicity in the general discussion herein, the coefficients bᵢⱼ and the numbers bᵢ are assumed to be all positive integers.

Optimization problems that follow the formulation of Equation (1) can be readily cast into a QUBO formulation. A QUBO (short for “Quadratic Unconstrained Binary Optimization” as indicated above) problem is an optimization problem that can be formulated as the minimization of a function of the form

$$Q ( x ) = {\sum }_{i = 1}^{n} {\sum }_{j = i}^{n} {Q}_{ij} {x}_{i} {x}_{j} \qquad ( 2 )$$

where xᵢ∈{0, 1}∀i=1, . . . , n. As the name suggests, these optimization problems are only concerned with minimizing a quadratic objective function with binary variables since there are no constraint. To cast a problem formulated as in Equation (1) into a QUBO formulation only requires turning linear equality constraints into quadratic penalties, which is a technique that is used typically in certain approaches to solving optimization problems. Hence, the QUBO formulation corresponding to an optimization problem in the form of Equation (1) amounts to minimizing the function

$${\sum }_{i = 1}^{n} {\sum }_{j = i}^{n} {Q}_{ij} {x}_{i} {x}_{j} + {\sum }_{j = 1}^{m} {( {\sum }_{i = 1}^{n} {b}_{ji} {x}_{i} - {b}_{j} )}^{2} . \qquad ( 3 )$$

In the QUBO model, the interest is in finding the assignment x* which minimizes the objective function [symbol] , that is, compute

$${x}^{*} = {min}_{x ∈ {\{ 0 , 1 \}}^{n}} Q ( x ) .$$

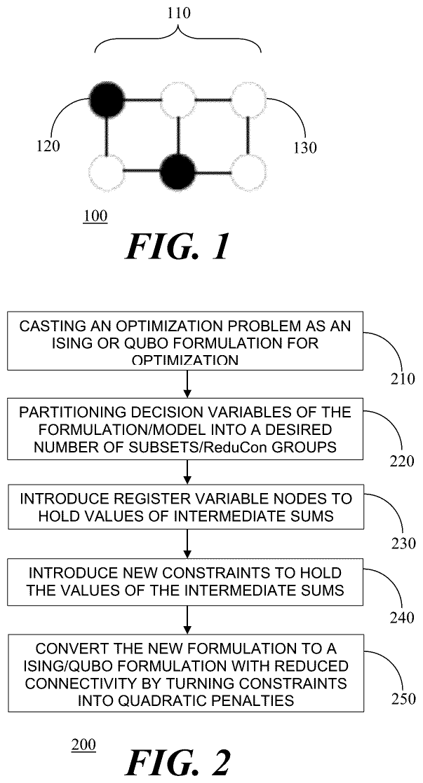

It should be further noted that a model equivalent to the QUBO one is the Ising model. The Ising model was initially presented as a mathematical model for representing physical systems, such as magnets. The Ising model consists of variables called spins, which can take values −1 or 1, and which interact with each other according to a given graph structure. Such a graph structure is shown in FIG. 1. FIG. 1 depicts an illustration 100 of a conventional Ising lattice 110 for a 2 by 3 system. The lattice 110 is a 2 by 3 lattice of spins, where first spins 120 having a value −1 are depicted in black and second spins 130 having a value 1 are depicted in white.

The model assigns a value (often called “energy”) to each configuration of spins through a particular function (often called “Hamiltonian”) of the following form

$$ℋ ( σ ) = - {\sum }_{i , j = 1}^{n} {J}_{ij} {σ}_{i} {σ}_{j} - {\sum }_{i = 1}^{n} {h}_{i} {σ}_{i} \qquad ( 4 )$$

where σᵢ∈{−1, 1}∀i=1, . . . , n. In order to map an Ising formulation to a QUBO one, the range of the variables are changed from {−1, 1} to {0, 1}, which is achieved by substituting each variable σᵢ with 2xᵢ−1. Similarly, one can start from a QUBO problem and substitute each variable xᵢ with (σᵢ+1)/2 to retrieve the corresponding Ising formulation. Thus, hereinafter, a mention of an Ising/QUBO formulation can refer to any optimization problem which demands the minimization of a quadratic objective function with variables that can only take two arbitrary distinct values, and where there is no further constraint on the variables.

Similar to the QUBO model, in the Ising model, the interest is in finding the assignment which minimizes the function [symbol] in Equation (4), that is, compute

$${σ}^{*} = {min}_{σ ∈ {\{ - 1 , 1 \}}^{n}} ℋ ( σ ) .$$

One is often also interested in sampling configurations with low-energy. Note that for either of the two models, adding a constant term to the function to be minimized does not alter the structure of the energy spectrum and, in particular, the lowest energy configurations remain unchanged.

A convenient way to visualize an Ising/QUBO formulation is through a graph G=(V,E), which is a structure containing a set of objects V (called “nodes”) linked together by a set of “edges” E, where each edge links a pair of nodes. In the context of Ising/QUBO problems, the corresponding graph has the set of nodes V={1, . . . , n}, where each node i∈V corresponds to the variable xᵢ in the problem. Each possible pair of nodes (i,j)∈V×V, which represent the term Qᵢⱼxᵢxⱼ that appear in the sum of Equation (2), belongs to the set of edges only if Qᵢⱼ≠0. As an example of an Ising formulation viewed as a graph, one can consider an Ising lattice, where spins are placed on a rectangular grid and connected to their nearest neighbours as shown in the lattice illustration 100 of FIG. 1.

The connectivity of an Ising/QUBO problem is of particular interest since when applying a Houdayer move, the connectivity plays a large role in how successful the move is. Ising/QUBO problems that are very connected, that is where most coefficients Qᵢⱼ are non-zero, tend to prevent Houdayer moves from yielding an output which differs from the input, rendering the move useless.

Since mentions of how connected a graph is are recurrent hereinafter, a commonly used measure called “graph density” is introduced. Let G=(V,E) be an undirected graph. The graph density d(G) of G is defined as the ratio of the number of edges |E| to the maximum possible number of edges, that is

$$d ( G ) = \frac{2 \vert E \vert}{\vert V \vert ( \vert V \vert - 1 )} .$$

In accordance with the methods and systems of the present embodiments, the optimization problems considered are those that can be formulated as those in Equation (1) since they can be further cast into Ising/QUBO problems. In such a case, it is then possible to use tools like the Houdayer move and its variants. Moreover, the optimization problems considered are not restricted to the study of spin systems in physics, meaning that general optimization problems may be considered where any pairwise interaction can happen. In particular, the methods and systems in accordance with the present embodiments work even for optimization problems which have interactions between every pair of variables. In order to do so, the approaches of the methods and systems in accordance with the present embodiments actively modify the input given to the Houdayer move itself, resulting in a higher chance of successful optimization.

As an example, the number partitioning problem, such as used in logistics for efficient cargo packing and shipping, can be formulated as an Ising modelC={c₁, c₂, . . . , cₙ}et [symbol] be a finite set of positive numbers. When one wishes to find a partition of C into two disjoint subsets A and C\A such that the sum of the elements in both sets is equal, i.e., Σ_{a∈A}a=Σ_{b∈C\A}b, one can fit this into an Ising formulation by defining the Hamiltonian function set out in Equation (4) as seen in Equation (5):

$$ℋ ( σ ) = {( {\sum }_{i = 1}^{n} {c}_{i} {σ}_{i} )}^{2} = {\sum }_{i , j = 1}^{n} {c}_{i} {c}_{j} {σ}_{i} {σ}_{j} \qquad ( 5 )$$

which is of the desired form −ΣᵢⱼJᵢⱼσᵢσⱼ−Σᵢhᵢσᵢ of an Ising model, with Jᵢⱼ=−cᵢcⱼ and hᵢ=0 and ∀i, j∈{1, 2, . . . , n}.

More generally, real-life optimization problems, such as logistics and job shop optimized scheduling, improved biological self-assembly via optimized protein folding, and optimized financial portfolio trading, can be expressed in the form of Equation (1), so that the corresponding Ising/QUBO formulation can be used for optimization and reducing connectivity in accordance with the methods and systems of the present embodiments.

As mentioned hereinabove, the Houdayer move and its derivatives exhibit the interesting property that they are able to perform isoenergetic moves, i.e., moves that preserve the total energy of the input configurations. Although useful in many situations, the Houdayer move has the downside that in practice, to be successful, it requires the number of pairwise interactions between variables to be small. Equivalently, the graph connectivity underlying the problem should not be too connected. To alleviate this issue for an important class of problems and to advantageously provide enhanced solutions for real-world optimization problems, a technique for reducing connectivity is provided in accordance with the methods and systems of the present embodiments where, given a certain Ising/QUBO problem, a new graph structure with reduced connectivity is generated while being equivalent to the original problem. In connection with the methods and systems of the present embodiments, this technique is referred to as “ReduCon”. ReduCon advantageously provides the skilled person the possibility to apply the Houdayer move to certain very strongly connected real-world problems to provide solutions in situations where other techniques would most likely fail, as the Houdayer move would most likely fail on the original underlying graph.

Although originally developed for two-dimensional lattices, the Houdayer move has been altered in various works in order to work on lattices in any space dimension. Such variations differ from the ReduCon techniques in accordance with the methods and systems of the present embodiments in several important application-constraining ways. The conventional Houdayer algorithm and its variations tend to yield poor performance in the general case where interactions happen between arbitrary pairs of variables in a system. In addition, application of the Houdayer algorithm and its variations are restricted to certain pre-defined conditions, which are typically known to be favourable for a successful outcome (i.e., the output is different to the input). However, this methodology does not improve the intrinsic success rate of the Houdayer move; it only makes use of the Houdayer move when the input is such that the technique is most likely to work.

In order to provide optimization solutions even for problems which have interactions between every pair of variables, the methods and systems in accordance with the present embodiments actively modify the input given to the Houdayer move itself, resulting in a higher chance to make it successful.

In order to make use of the methods and systems in accordance with the present embodiments, one should know how to formulate an optimization problem of interest in the form of Equation (1). As mentioned hereinabove, for simplicity, we consider in the following such optimization problems but with only one linear equality constraint, yielding the formulation

$$minimize {\sum }_{i = 1}^{n} {\sum }_{j = 1}^{n} {Q}_{ij} {x}_{i} {x}_{j} \qquad ( 6 )$$

$$subject to {\sum }_{i = 1}^{n} {b}_{i} {x}_{i} = b \qquad ( 7 )$$

$${x}_{i} ∈ \{ 0 , 1 \} ∀ i ∈ \{ 1 , … , n \}$$

Moreover, the user should be able to represent a solution of the discrete problem through a configuration of the variables xᵢ's in the binary formulation specified above. Note that if the problem statement has an inequality constraint Σᵢ₌₁bᵢxᵢ≤b instead of an equality, it can be converted to an equality by adding t=└ log₂(b)┘+1 “slack” variables s₁, . . . , sₜ∈{0,1}. The constraint then becomes Σᵢ₌₁ⁿbᵢxᵢ+Σᵢ₌₁^{t}2ⁱ⁻¹sᵢ=b, which fits our formulation, but there are now n+t binary variables, namely x₁, . . . , xₙ and s₁, . . . , sₜ. If the problem is specified using Ising variables (that is variables take values in {−1,1}) as

$$minimize {\sum }_{i = 1}^{n} {\sum }_{j = i + 1}^{n} {J}_{ij} {σ}_{i} {σ}_{j} + {\sum }_{i = 1}^{n} {h}_{i} {σ}_{i} \qquad ( 8 )$$

$$subject to {\sum }_{i = 1}^{n} {c}_{i} {σ}_{i} = c \qquad ( 9 )$$

$${σ}_{i} ∈ \{ - 1 , 1 \} ∀ i ∈ \{ 1 , … , n \}$$

it can be converted to the formulation in Equation (6) through the substitution σᵢ→2xᵢ−1, yielding a new formulation with x∈{0, 1}∀i=1, . . . n as desired.

In order to input such a formulation in practice, one needs to specify the values [symbol] ᵢⱼ, bᵢ and b, which can be given in various ways. For example, the Qᵢⱼ's can be specified using an n-by-n matrix Q with elements (Q)ᵢⱼ=Qᵢⱼ, and a list of pairs (i,j) of indices with the corresponding weight [symbol] ᵢⱼ. The coefficients bᵢ can be conveniently given as a sequence [b₁, . . . , bₙ], while the coefficient b can be given as is.

To see when the methods and systems in accordance with the present embodiments can be used, we first convert the formulation to a QUBO formulation by turning the linear constraint in Equation (7) into a quadratic penalty, yielding the new objective function

$$Q ( x ) = {\sum }_{i = 1}^{n} {\sum }_{j = 1}^{n} {Q}_{ij} {x}_{i} {x}_{j} + {( {\sum }_{i = 1}^{n} {b}_{i} {x}_{i} - b )}^{2} \qquad ( 10 )$$

As mentioned hereinabove, we visualize the QUBO problem as a graph G=(V,E) with vertices V={1, . . . , n}, and where there is an edge (i,j)∈E, the quadratic term xᵢxⱼ has a non-zero coefficient. The resulting graph visualizing the QUBO problem can thus be more or less connected depending on the number of distinct quadratic terms, and the goal of the ReduCon methods and systems in accordance with the present embodiments is to reduce this connectivity and thereby advantageously improve the success of the Houdayer move and its variants.

In Equation (10), the first part Σᵢ₌₁ⁿΣⱼ₌₁ⁿQᵢⱼxᵢxⱼ is the initial quadratic objective function that appears in Equation (7) and already induces some edges in the underlying graph. This “initial” connectivity is a constraint in regards to the ReduCon methods and systems of the present embodiments in that it cannot be reduced in accordance with the present embodiments. Since the ReduCon methods and systems in accordance with the present embodiments cannot prevent variables in the “initial” connectivity from being connected, the Houdayer move is bound to perform poorly if the “initial” connectivity is too dense. Accordingly, in accordance with the present embodiments, it is assumed that this first quadratic double-sum Σᵢ₌₁ⁿΣⱼ₌₁ⁿQᵢⱼxᵢxⱼ) induces a low number of pairwise interactions, or even none (which happens when Qᵢⱼ=0 for all i≠j).

The second part of Equation (10), (Σᵢ₌₁ⁿb; xᵢ−b)²=Σ_{i,j=1}ⁿbᵢbⱼxᵢxⱼ−2bΣᵢ₌₁ⁿbᵢxᵢ+b² accounts for the linear constraint and adds edges (i,j) to G whenever bᵢ>0 and bⱼ>0. In a worst case, all bᵢ's are strictly positive, inducing a fully-connected topology. This is the connectivity that the ReduCon methods and systems in accordance with the present embodiments are able to reduce. And the ReduCon methods and systems in accordance with the present embodiments reduce this connectivity by introducing new variables to the QUBO problem, thereby advantageously enabling application of the Houdayer move and its variants.

In order to reduce the connectivity, the ReduCon methods and systems in accordance with the present embodiments introduce extra variables which act as intermediate registers to hold partial values of the sum Σᵢ₌₁ⁿbᵢxᵢ. This way, not all variables need to interact, since some values are stored into the intermediate registers. In the following, the resulting graph representing the problem is denoted as G′=(V′, E′).

Referring to FIG. 2, a flowchart 200 depicts steps of the ReduCon methods in accordance with the present embodiments. Initially, at step 210, an optimization problem following the structure of Equation (6) is cast as an Ising/QUBO formulation for optimization in accordance with the ReduCon methods of the present embodiments.

At step 220, the set {1, . . . , n} representing all decision variables are partitioned into a desired number k of subsets G₁, . . . , Gₖ⊆{1, . . . , n}. With these subsets, one can define which intermediate values to store. In the present example, the partial sums S₁=Σ_{i∈G}_{₁}bᵢxᵢ, S₂=Σ_{i∈G}_{₁}_{∪G}_{₂}bᵢxᵢ all the way to Sₖ=Σ_{i∈G}_{₁}_{∪ . . . ∪G}_{₂}bᵢxᵢ; can be stored. Hereinafter, the subsets G₁, . . . , Gₖ are sometimes referred to as ReduCon groups.

At step 230, “register” variables are introduced to hold the values of the intermediate sums (i.e., the partial sums S₁=Σ_{i∈G}_{₁}, bᵢxᵢ, S₂=Σ_{i∈G}_{₁}_{∪G}_{₂}bᵢxᵢ . . . . Sₖ=Σ_{i∈G}_{₁}_{∪ . . . ∪G}_{ₖ}bᵢxᵢ). Since the sum Sᵢ can take values in {0,1, . . . , Σ_{j∈G}_{₁}_{∪ . . . ∪G}_{ᵢ}bⱼ} depending on the values of x₁, . . . , xₙ, the number of bits necessary to represent the value of the sum is |Rᵢ|=[log Σ_{j∈G}_{₁}_{∪ . . . ∪G}_{ᵢ}bⱼ]+1. Thus, for each Sᵢ a corresponding set with |Rᵢ| binary variables Rᵢ={r₁⁽ⁱ⁾, . . . , r_{|R}_{ᵢ}_{|}⁽ⁱ⁾} is introduced which forms a register to hold the value of the sum. In accordance with the methods and systems of the present embodiments, the “register” variables are meant to be binary representations of the actual value of the sum, that is Sᵢ=Σⱼ₌₁^{|R}^{ᵢ}^{|}2^{j-1}rⱼ⁽ⁱ⁾.

At step 240, new constraints are introduced so that the new formulation is equivalent to the original one. Indeed, some constraints need to be imposed to ensure that the register variables are indeed holding the values of the intermediate sums, which can be specified through the equalities of Equation (10) to finally rewrite the original constraint Σᵢ₌₁ⁿbᵢxᵢ=b of Equation (7) using the last register's variables Σᵢ₌₁^{|R}^{ₖ}^{|}2ⁱ⁻¹rᵢ^{(k)}=b:

$$\text{?} {b}_{i} {x}_{i} = {\sum }_{i = 1}^{\vert {R}_{1} \vert} {2}^{i - 1} {r}_{i}^{( 1 )} \qquad ( 11 )$$

$${\sum }_{i = 1}^{\vert {R}_{1} \vert} b {2}^{i - 1} {r}_{i}^{( 1 )} + \text{?} {b}_{i} {x}_{i} = {\sum }_{i = 1}^{\vert {R}_{2} \vert} {2}^{i - 1} {r}_{i}^{( 2 )}$$

$${\sum }_{i = 1}^{\vert {R}_{2} \vert} {2}^{i - 1} {r}_{i}^{( 2 )} + \text{?} {b}_{i} {x}_{i} = {\sum }_{i = 1}^{\vert {R}_{3} \vert} {2}^{i - 1} {r}_{i}^{( 3 )}$$

$$⋮$$

$${\sum }_{i = 1}^{\vert {R}_{k - 1} \vert} {2}^{i - 1} {r}_{i}^{( k - 1 )} + \text{?} {b}_{i} {x}_{i} = {\sum }_{i = 1}^{\vert {R}_{k} \vert} {2}^{i - 1} {r}_{i}^{( k )}$$

$$\text{?} \text{indicates text missing or illegible when filed}$$

Then, at step 250, the new formulation is converted to a QUBO formulation. By turning constraints into quadratic penalties this yields the new function to minimize as shown in Equation (12):

$$Q ( x ) = {\sum }_{i = 1}^{n} \text{?} {Q}_{ij} {x}_{i} {x}_{j} + \qquad ( 12 )$$

$${( \text{?} {b}_{i} {x}_{i} - \text{?} {2}^{i - 1} \text{?} )}^{2} +$$

$${( \text{?} {2}^{i - 1} \text{?} + \text{?} - \text{?} {2}^{i - 1} \text{?} )}^{2} +$$

$$⋮$$

$${( \text{?} {2}^{i - 1} \text{?} + \text{?} - \text{?} {2}^{i - 1} \text{?} )}^{2} +$$

$${( \text{?} {2}^{i - 1} \text{?} - b )}^{2}$$

$$\text{?} \text{indicates text missing or illegible when filed}$$

inducing a graph G′=(V′, E′) which, advantageously, is not fully connected—i.e., thereby reducing connectivity in accordance with the ReduCon methods and systems of the present embodiments.

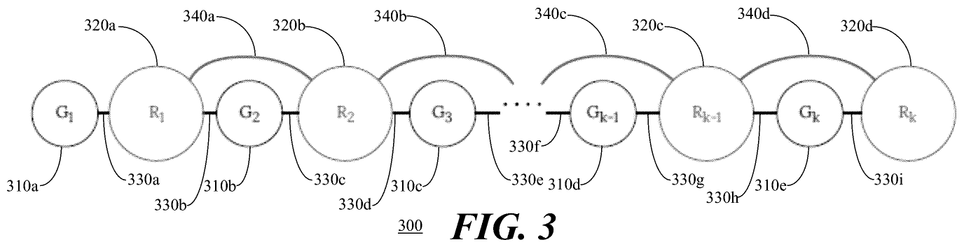

The resulting connectivity can be determined as follows. As discussed hereinabove, it is assumed that Σᵢ₌₁ⁿΣⱼ₌₁ⁿQᵢⱼxᵢxⱼ induces a low number of interactions between the decision variables. One can show that the new interactions through Equation (12) allow one to lower the connectivity overall. Indeed, the first quadratic penalty (Σ_{i∈G}_{ᵢ}bᵢxᵢ−Σᵢ₌₁^{|R}^{₁}^{|}2ⁱ⁻¹rᵢ⁽¹⁾)², for example, involves variables {xᵢ: i∈G₁} and {rᵢ⁽¹⁾:i=1, . . . , |R₁|}, the second quadratic penalty (Σᵢ₌₁^{|R}^{₁}^{|}2ⁱ⁻¹rᵢ⁽¹⁾+Σ_{i∈G}_{ᵢ}bᵢxᵢ−Σᵢ₌₁^{|R}^{₁}^{|}2ⁱ⁻¹rᵢ⁽²⁾)² involves variables {x₂:i∈G₂}, {rᵢ⁽¹⁾:i=1, . . . , |R₁|} and {rᵢ⁽²⁾:i=1, . . . , |R₂₁|}, and so on. Thus, it is clear that, advantageously, at no point variables coming from non-adjacent registers interact. These missing interactions imply that the resulting graph is not fully-connected, i.e., connectivity can be reduced in accordance with the ReduCon methods and systems in accordance with the present embodiments. Going through each penalty reveals the structure of the new graph. Referring to FIG. 3, an illustration 300 visualizes the graph structure resulting from the ReduCon methods and systems. In this depiction, it is assumed that variables in different ReduCon groups do not interact. When applying the ReduCon methods and systems, decision variables 310 are grouped into k ReduCon groups G₁, . . . , Gₖ, and register variables 320 are added, forming registers R₁, . . . , Rₖ. Within each circle box 310a to 310e representing ReduCon groups and each circle box 320a to 320d representing registers, variables are fully connected. There are also edges 330 between each decision variable of each ReduCon group and the register variables from previous and next registers (links 330a to 330i). Finally, edges 340 are also added between variables of adjacent registers (links 340a to 340d) in accordance with present embodiments. In the illustration 300, each edge 330 and each edge 340, actually represent interactions between every variable contained within each of the two entities connected by the edge.

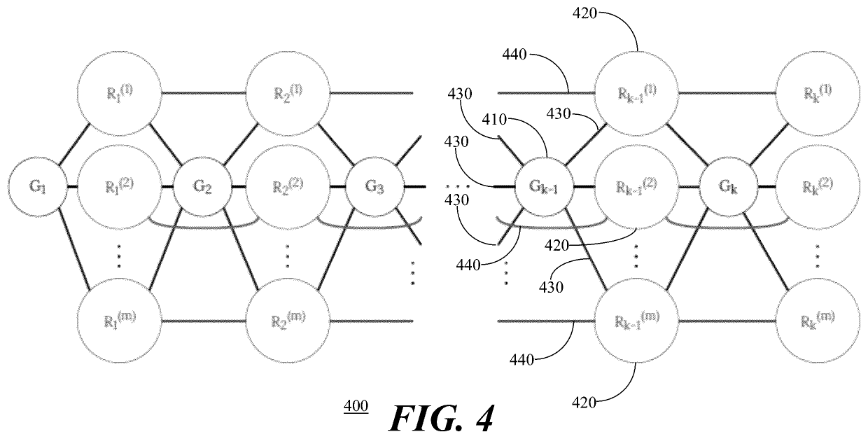

There are multiple ways in which ReduCon can be modified to handle more general constraints in accordance with the methods and systems of the present embodiments. For example, one can consider a problem of the general form of Equation (1) with m constraints. In such a case, after grouping, one needs registers to store partial sums corresponding to each constraint. That is, after choosing k ReduCon groups G₁, . . . , Gₖ to partition the decision variables into, the lth partial sum for the jth constraint is now Sᵢ^{(j)}=Σ_{i∈G}_{₁}_{∪ . . . ∪G}_{ⱼ}bⱼᵢxᵢ, meaning a corresponding register Rᵢ^{(j)} for l=1, . . . , k and j=1, . . . , m must be introduced. Finally, by adding extra constraints to make the problem equivalent, a topology as depicted in the illustration 400 of FIG. 4 results. In the illustration 400 (note not all items are labeled with a reference numeral for simplicity), it is assumed that variables in different ReduCon groups do not interact. As shown in the illustration 400, when applying the general connectivity reduction process in accordance with the methods and systems of the present embodiments, decision variables 410 are grouped into k groups G₁, . . . , Gₖ and register variables 420 are added for all constraints, forming registers Rₗ^{(j)} for l=1, . . . , k and j=1, . . . , m. Within each circle box representing groups 410 and registers 420, variables are fully connected. There are also edges 430 between each variable of each group and the variables from previous and next registers of the same constraint. In accordance with the present embodiments, edges 440 are also added between variables of adjacent registers corresponding to the same constraint. In the illustration 400, each edge 430 and each edge 440 actually stands for interactions between every variable contained within each of the two entities connected by the edge.

Another way in which ReduCon can be modified to handle more general constraints in accordance with the methods and systems of the present embodiments is where one considers that the coefficients bᵢⱼ in the linear constraint(s) are not necessarily positive integers, but real numbers instead. In this case, one needs to change the representation of the registers' values since, in conventional binary representation, they can only handle positive integer values. The simplest way to do so is to use a floating-point representation for each register's value, such as that described in the IEEE 754 standard. Depending on what precision is needed, each register will need a certain number of bits defined by the format chosen. These variables could be binary 32 (i.e., 32 binary variables), binary 64 (i.e., 64 binary variables), or binary 128 (i.e., 128 binary variables).

In the formulation resulting from the ReduCon methods and systems in accordance with the present embodiments (i.e., the formulation formed at step 250 of the flowchart 200 (FIG. 2)), the variables x₁, . . . , xₙ are present as before, but extra binary variables are introduced for each introduced register. In total, the new number of variables (or nodes |V′| in G′) is described by Equation (13):

$$\begin{matrix}\vert {V}^{′} \vert = n + {\sum }_{i = 1}^{k} \vert {R}_{i} \vert \\ = n + {\sum }_{i = 1}^{k} ( ⌊ log \text{?} {b}_{j} ⌋ + 1 ) \\ = n + k + {\sum }_{i = 1}^{k} ⌊ log \text{?} {b}_{j} ⌋\end{matrix} \qquad ( 13 )$$

$$\text{?} \text{indicates text missing or illegible when filed}$$

The number of edges can be computed by looking at the illustration 300 of FIG. 3 as follows:

$$\begin{matrix}\vert {E}^{′} \vert = \# ( edges within each group ) + \\ \# ( edges within each register ) + \\ \# ( edges between each group and adjacent registers ) + \\ \# ( edges between adjacent registers ) \\ = {\sum }_{j = 1}^{k} ( \begin{matrix}\vert {G}_{j} \vert \\ 2\end{matrix} ) + {\sum }_{j = 1}^{k} ( \begin{matrix}\vert {R}_{j} \vert \\ 2\end{matrix} ) + {\sum }_{j = 1}^{k} ( \vert {G}_{j} \vert \cdot \vert {R}_{j} \vert + \vert {G}_{j + 1} \vert \cdot \vert {R}_{j} \vert ) + \vert {G}_{k} \vert \cdot \vert {R}_{k} \vert + {\sum }_{j = 1}^{k} \vert {R}_{j} \vert \cdot \vert {R}_{j + 1} \vert \\ = {\sum }_{j = 1}^{k} ( ( \begin{matrix}\vert {G}_{j} \vert \\ 2\end{matrix} ) + ( \begin{matrix}\vert {R}_{j} \vert \\ 2\end{matrix} ) ) + {\sum }_{j = 1}^{k - 1} ( \vert {G}_{j} \vert \cdot \vert {R}_{j} \vert + \vert {G}_{j + 1} \vert \cdot \vert {R}_{j} \vert + \vert {R}_{j} \vert \cdot \vert {R}_{j + 1} \vert ) + \vert {G}_{k} \vert \cdot \vert {R}_{k} \vert\end{matrix} \qquad ( 14 )$$

As an example, consider the following formulation with five variables:

$$minimize {\sum }_{i = 1}^{5} {c}_{i} {x}_{i} \qquad ( 15 )$$

$$subject to {\sum }_{i = 1}^{5} {x}_{i} = 1$$

$${x}_{i} ∈ \{ 0 , 1 \} ∀ i ∈ \{ 1 , … , 5 \}$$

This example indeed fits the framework of the ReduCon methods and systems, with

$${Q}_{ij} = \{ \begin{matrix}\sqrt{{c}_{i} {c}_{j}} , & if i = j \\ 0 , & otherwise\end{matrix} .$$

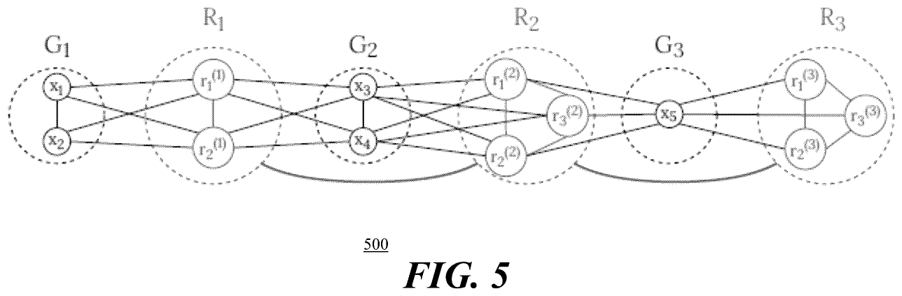

Once it is converted into QUBO form, the function to optimize becomes Q(x)=Σᵢ₌₁⁵cᵢxᵢ+(Σᵢ₌₁⁵−1)², giving rise to a fully connected topology due to the penalty term (second term), since all variables are part of it. The connectivity thus has a density d(G)=1. Since the interactions arise from the linear constraint, the ReduCon prescription can thus be used and, for example, create k=3 groups as follows: G₁={1,2}, G₂={3,4} and G₃={5} as shown in the illustration 500 in FIG. 5 which depicts the resulting graph after applying ReduCon on the example in Equation (15). In this case, |R₁|=└ log(Σ_{i∈G}_{₁}1)┘+1=└ log(2)┘+1=2 bits must be introduced for the first register, |R₂|=└ log(Σ_{i∈G}_{₁}_{∪G}_{₂}1)┘+1=└ log(4)┘+1=3 bits must be introduced for the second one, and |R₃|=└ log(Σ_{i∈G}_{₁}_{∪G}_{₂}_{∪G}_{₃}1)┘+1=└ log(5)┘+1=3 bits must be introduced for the third one. The resulting graph depicted in the illustration 500 again shows how connectivity is reduced in accordance with the ReduCon methods and systems of the present embodiments.

The new number of variables is now V′=5+2+3+3=13, and so the maximum number of edges is

$$( \begin{matrix}{V}^{′} \\ 2\end{matrix} ) = ( \begin{matrix}13 \\ 2\end{matrix} ) = 78.$$

Computing the number of edges using Equation (14) as follows:

$$\begin{matrix}\vert {E}^{′} \vert = {\sum }_{j = 1}^{k} ( ( \begin{matrix}\vert {G}_{j} \vert \\ 2\end{matrix} ) + ( \begin{matrix}\vert {R}_{j} \vert \\ 2\end{matrix} ) ) + {\sum }_{j = 1}^{k - 1} ( ( \vert {G}_{j} \vert \cdot \vert {R}_{j} \vert + \vert {G}_{j + 1} \vert \cdot \vert {R}_{j} \vert + \vert {R}_{j} \vert \cdot \vert {R}_{j + 1} \vert ) + \vert {G}_{k} \vert \cdot \vert {R}_{k} \vert \\ = ( \begin{matrix}2 \\ 2\end{matrix} ) + ( \begin{matrix}2 \\ 2\end{matrix} ) + ( \begin{matrix}1 \\ 2\end{matrix} ) + ( \begin{matrix}2 \\ 2\end{matrix} ) + ( \begin{matrix}3 \\ 2\end{matrix} ) + ( \begin{matrix}3 \\ 2\end{matrix} ) + 2 \cdot 2 + 2 \cdot 2 + 2 \cdot 3 + 3 \cdot 1 + 1 \cdot 3 + 2 \cdot 3 + 3 \cdot 3 \\ = 44\end{matrix} , \qquad ( 16 )$$

yields a graph density of d(G′)=44/78≈0.564 for the new graph. Hence, thanks to the transformation induced by the ReduCon methods and systems in accordance with the present embodiments, the original fully-connected problem is turned into a much sparser one.

Hereinabove, it has been discussed how ReduCon needs to group decision variables into different sets (i.e., into the ReduCon groups) in order to build and store partial values of the sums involved in the linear constraints. The question remains whether there exists an optimal way to do so and, in this context, what optimal means. Ultimately, the goal of the ReduCon methods and systems in accordance with the present embodiments is to reduce graph connectivity to allow the use of Houdayer moves. This means that it is preferred that for most pairs of configurations, applying the Houdayer move results in a successful transition, one where the resulting pair of configurations is different from the starting one. Hence, what is defined as the optimal groupings of variables is one for which the resulting graph yields the highest chance of success for the Houdayer move, regardless of the pair of configurations given.

Generally, as discussed hereinabove, the Houdayer move tends to be more successful when the problem at hand has a weakly-connected underlying graph. To obtain a new graph in accordance with present embodiments, the ReduCon methods and systems perform a very specific choice of addition of nodes and how they relate to each other. This means that even though the graph density may be reduced, it could be that certain choices of groupings can only yield unsuccessful Houdayer moves.

This can be made explicit through simple experiments where, for a certain problem, how different groupings lead to different densities and different rates of success for the Houdayer move are compared. Experiments are performed as follows. For a desired choice of ReduCon groups, apply the ReduCon method in accordance with the present embodiments to an input problem with an underlying graph G to get a new formulation with graph G′, from which a new graph density d(G′) can be deduced. Secondly, repeat m times the following three steps (or, if the number of variables n in the problem is low, consider all 2²ⁿ possible pairs): (a) sample uniformly at random a pair of configurations (σ⁽¹⁾, σ⁽²⁾) in the original problem; (b) convert the pair of configurations to a corresponding pair (σ′⁽¹⁾, σ″⁽²⁾) in the new formulation G′, and then try to perform a Houdayer move and record whether the Houdayer move is a success or not. And, thirdly, return the density d(G′) together with the “success rate”

$$\frac{1}{n} {\sum }_{i = 1}^{m}$$

{sample i was successful}.

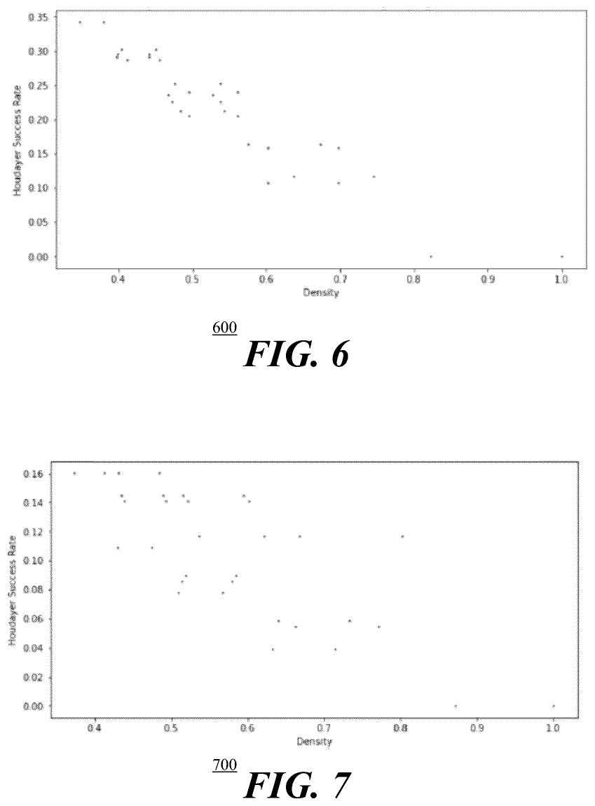

Repeating this process for groupings of interest (potentially all groupings), one can collect all resulting densities and success rates and plot them on a two-dimensional plane to visualize the performance of different groupings. For example, assume a problem with six variables x₁, . . . , x₆ and linear constraint Σᵢ₌₁⁶xᵢ=1, that is xᵢ=1, ∀i∈{1, . . . , 6}. The process explained above is repeated for all possible groupings and, since the number of variables is low, all 2²⁻⁶=4096 pairs of configurations are considered. A graph 600 in FIG. 6 plots densities versus Houdayer success rates when using methods for all possible groupings with six variables in accordance with the present embodiments when coefficients in the linear constraint are all equal, where each point corresponds to different grouping. Although the trend suggests that a lower density implies more successful Houdayer moves, graphs with different densities can yield the same success rate.

Suppose instead of having coefficients being equal in the linear equality constraint, coefficients of different integers, such as b₁=b₂=3, b₃=b₄=2, b₅=1, b₆₌₈, are used. FIG. 7 depicts a graph 700 of the densities versus the Houdayer success rates when using ReduCon methods and systems in accordance with the present embodiments for all possible groupings with six variables in accordance with the present embodiments when coefficients in the linear constraint are different. The results in the graph 700 show that even when a graph's density is rather large, the success of Houdayer moves can be still appreciably high (note, the point with density≈0.8 and success ratio≈0.12), whereas some lower density graphs might reach lower success rates (e.g., the point with density≈0.65 and success ratio≈0.04). It can thus be concluded that graph density is not the most deciding factor.

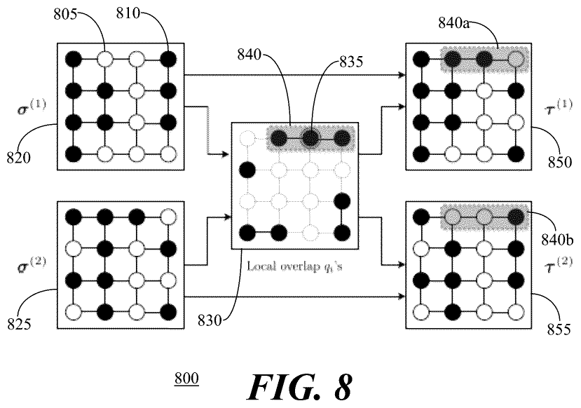

To understand which grouping of variables is best, one should go back to the definition of the Houdayer move. The Houdayer move works with configurations of spins, that is when variables take values in {−1,1}. To use the Houdayer move with binary variables, one can use the conversion to the formulation in Equation (6) through the one-to-one transformation σᵢ=2xᵢ−1, yielding a new formulation with xᵢ∈{0,1}∀i∈1, . . . , n. At the heart of the Houdayer move is the selection of multiple variables to be flipped, which is done by first computing the “local overlap” at each site between a pair of spin configurations (σ⁽¹⁾, σ⁽²⁾), which informs about the similarity of spins between the configurations. Formally, the local overlap at site i∈V between the two configurations is defined as qᵢ=σᵢ⁽¹⁾σᵢ⁽²⁾). After that, the Houdayer moves picks a group of variables which differ between the two configurations and which form a connected component. Finally, the values of the chosen variables are flipped in both configurations, possibly yielding a new pair of configurations. The process is visualized in illustration 800 in FIG. 8 for a 2-dimensional lattice graph. The illustration 600 depicts a visual representation of the Houdayer move, where spins 805 with value 1 are white, and spins 810 with value −1 are black. The Houdayer move starts with a pair of independent spin configurations σ⁽¹⁾ 820 and σ⁽²⁾ 825 and first computes their local overlap 830 qᵢ=σᵢ⁽¹⁾σᵢ⁽²⁾ at each site (or vertex) i, revealing where spins differ between the two configurations. One of the sites 835 with overlap value qᵢ=−1 is then chosen uniformly at random and a corresponding cluster 840 is grown from the site 835. After that, the spins in the cluster 840a, 840b are swapped (i.e., flipped) between the two configurations, yielding a new pair τ⁽¹⁾ 850 and τ⁽²⁾ 855.

If the number of connected components is equal to one, then the Houdayer move has no choice but to pick that component, resulting in a failure in the sense that the resulting pair is identical to the original one, where just the configurations are swapped. Otherwise, if there is more than one connected component, new pairs of configurations at the same total energy can be reached. Thus, the goal is to have more than one connected component in the local overlap for any pair of configurations.

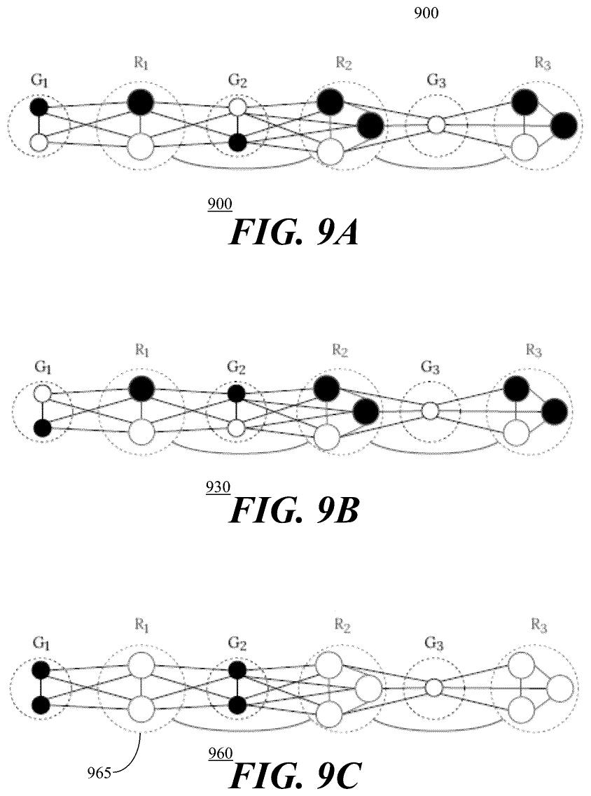

To create more than one connected component in the local overlap 840 of two given configurations, the variables which are equal (the nodes 805 in the illustration 800) must form some kind of “barrier” to allow the connected components formed by the nodes 810 to not join together, hence forming multiple clusters. To create such “barriers” in the graph that results from the ReduCon methods and systems in accordance with the present embodiments, we look again at the example discussed in connection with Equation (15). Let (σ⁽¹⁾, σ⁽²⁾) be a pair of configurations in the original problem with underlying graph G, and suppose that the two matching configurations in the new graph structure G′ created by the ReduCon methods and systems in accordance with the present embodiments are (σ′⁽¹⁾, σ′⁽²⁾). Referring to FIGS. 9A, 9B and 9C, two such configurations are shown (a first configuration 900 in FIG. 9A and a second configuration 930 in FIG. 9B) together with their resulting local overlap 960 in FIG. 9C. One can observe that even though variables are different in group G₁ and in group G₂ from the first configuration 900 to the second configuration 930, register R₁ has the same value in both configurations 900, 930. Because of this same value in both configurations 900, 930, R₁ forms a barrier 965 creating two connected components in the local overlap 960, the barrier 965 making the variables in G₁ and G₂ distinct clusters and enabling the use of a successful Houdayer move. If variables had differed only in G₁, then only one cluster would have been observed. In general, one of two things can happen: (a) if variables that are different between the configurations in the pair all belong to the same ReduCon group, they form only one connected component since variables in a group are fully-connected to each other or (b) some variables are in distinct groups, in which case they can form distinct connected components only if there is no way to connect them, which happens if a register in-between (e.g. R₁) acts as a barrier in the local overlap such as the barrier 965 in the local overlap 960.

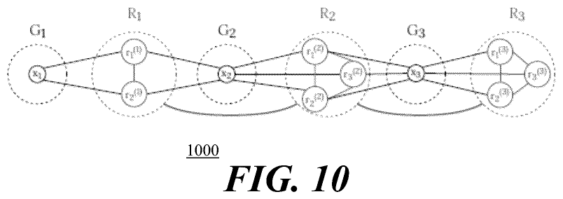

Knowing this, it can be deduced that a good grouping is one that for most pairs of configurations (σ⁽¹⁾, σ⁽²⁾), it is very likely that when converted to a pair (σ′⁽¹⁾, σ′⁽²⁾) in the new formulation with graph G′, at least one of the registers is going to have the same value for both configurations in the pair. To have more opportunities to create “register barriers”, a grouping which yields the greatest number of registers, which is the grouping formed by putting each decision variables xᵢ in its own ReduCon group, should be used. An example of such grouping is shown in an illustration 1000 in FIG. 10. The illustration 1000 depicts an exemplary resulting graph after applying the ReduCon methods and systems in accordance with the present embodiments. Each group is formed by a single variable and Gᵢ={i}, ∀i∈{1, . . . , n}. The final decision to make is the order of variables, since even if each group contains one variable, one should choose which group contains which variable. One heuristic which works particularly well is to look in the linear constraint at the coefficients bᵢ corresponding to variables xᵢ. If one orders ReduCon groups in such a way that variables which have a same coefficient the greatest number of times appear first, then ReduCon empirically works better. The first variables should be those whose coefficient's value appear most (but their order does not matter), and whenever there are ties, variables should be ordered in increasing order with respect to their coefficients. For example, if coefficients are given by b₁=73 b₂=32, b₃=12 b₄=45, b₅=45, b₆=32, the coefficient value which appears most are 32 and 45. Since both appear twice, there is a tie and so it is solved by taking the smallest coefficient first, that is 32. Hence, the first variables appearing should be those with that coefficient (that is, x₂ and x₆ should be in the first ReduCon groups) but their order does not matter. Then variables with coefficient 45 should appear (that is, x₄ and x₅), with again their order not mattering. Finally, the coefficients 12 and 73 both only appear once. This tie is resolved by making the variable x₃ appear first (since 12 is the smallest of the two coefficients), followed by x₁. Hence, an empirically good way to create ReduCon groups could be G₁={2}, G₂={6}, G₃={4}, G₄={5}, G₅={3}, G₆={1}.

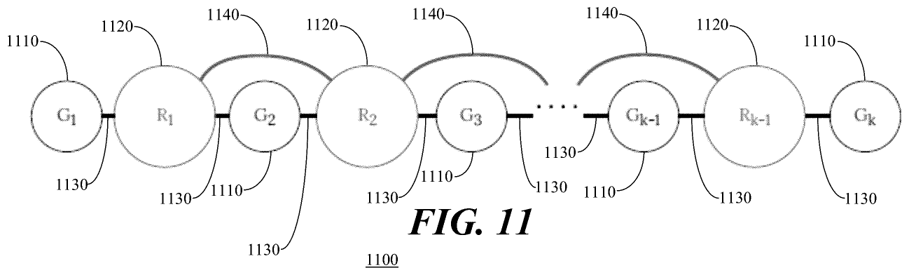

As has been described hereinabove, the creation of “register barriers” is what makes the Houdayer move successful. However, it is clear that the last register cannot act as a barrier since no group comes after it. Thus, the ReduCon methods and systems in accordance with the present embodiments can be slightly changed to simply drop the last register Rₖ and adjust the constraints depending on the last register accordingly. Specifically, instead of using the two constraints Σᵢ₌₁^{|R}^{ₖ₌₁}^{|}2ⁱ⁻¹rᵢ^{(k-1)}+Σ_{i∈G}_{ₖ}bᵢxᵢ=Σᵢ₌₁^{|R}^{ₖ}^{|}2ⁱ⁻¹rᵢ^{(k)} and Σᵢ₌₁^{|R}^{ₖ}^{|}2ⁱ⁻¹rᵢ^{(k)}=b, one just needs a single constraint Σᵢ₌₁^{|R}^{_{k−1}}^{|}2ⁱ⁻¹rᵢ^{(k-1)}+Σ_{i∈G}_{_{K}}bᵢxᵢ=b. This reduces the number of nodes and edges in the resulting graph G′, which advantageously speeds up the process and yields the same results as the original technique in accordance with the ReduCon methods and systems. Referring to FIG. 11, the result from the ReduCon methods and systems in accordance with the present embodiments when removing the last register nodes can be seen in an illustration 1100 showing how groups and registers are connected in the last-register-removal case. In the illustration 1100, it is assumed variables in different ReduCon groups do not interact. Within each circle box 1110 representing groups and each circle box 1120 representing registers, variables are fully connected. There are also edges 1130 between each decision variable of each group and the register variables from previous and next registers and edges 1140 added between variables of adjacent registers. In the illustration 1100, each edge 1130 and each edge 1140, stands for interactions between every variable contained within each of the two entities connected by the edge.

Even with the advantages provided by the ReduCon methods and systems in accordance with the present embodiments, time and storage space required to perform computations in the graph resulting from the ReduCon methods and systems, even though many nodes have been added, is not seriously impacted. The computation of connected components in the local overlap during the Houdayer move can be greatly simplified when the original objective function Σᵢ₌₁ⁿΣⱼ₌₁ⁿQᵢⱼxᵢxⱼ induces no interaction between variables in different ReduCon groups (i.e., when [symbol] =0 for two variables xᵢ and xⱼ that are in distinct ReduCon groups). In fact, since one already knows the structure of the resulting graph, the connected components can be determined once the registers that act as barriers are located. Hence, no graph structure needs to be stored in this case, reducing the storage space as well the running time of the Houdayer move.

Herein, a few applications of the ReduCon methods and systems in accordance with the present embodiments which show how they can be used together with the Houdayer move are presented. In all instances considered, the use of a Houdayer move on a pair of configurations (σ⁽¹⁾, σ⁽²⁾) is replaced by multiple steps. Denoting the underlying graph of the original optimization problem by G, the ReduCon methods and systems in accordance with the present embodiments allows one to retrieve the new graph G′ and to easily convert configurations between the two formulations.

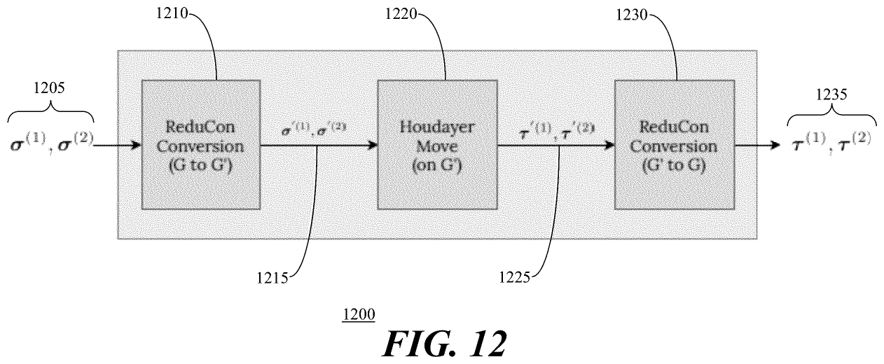

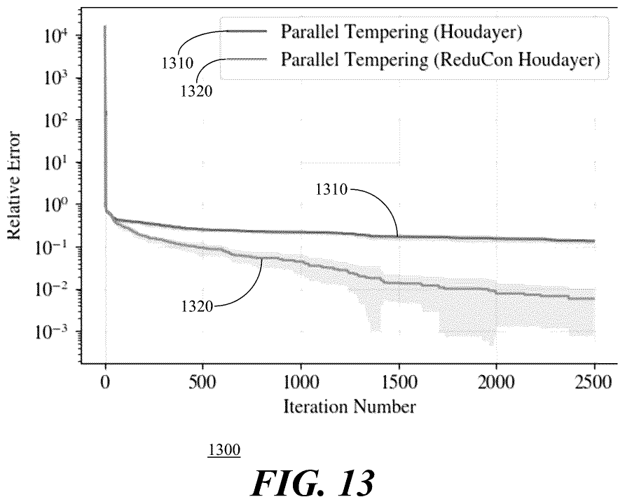

Referring to FIG. 12, a diagram 1200 illustrates application of a Houdayer move while using the ReduCon techniques (hereafter referred to as a “ReduCon Houdayer move”) in accordance with the methods and systems of the present embodiments. First, a ReduCon conversion step 1210 converts the pair of configurations (σ⁽¹⁾, σ⁽²⁾) 1205 from the optimization problem with G to the corresponding pair of configurations (σ′⁽¹⁾, σ′⁽²⁾) 1215 in the optimization problem with G′. Then, a Houdayer move 1220 is performed on G′, yielding a new pair of configurations (τ′⁽¹⁾, σ′⁽²⁾) 1225 in the optimization problem with G′. Thereafter, the pair of configurations (τ′⁽¹⁾, τ′⁽²⁾) 1225 from the optimization problem with G′ are converted 1230 to a corresponding pair of configurations (τ⁽¹⁾, τ⁽²⁾) 1235 in the optimization problem with G. G and G′ refer to the underlying graphs of the original formulation and the one created by ReduCon, respectively.

The first obvious application of the ReduCon Houdayer move in accordance with the present embodiments is in the context of Monte-Carlo methods, in particular in the context of Metropolis-Hastings algorithms and their derivatives such as simulated annealing or parallel tempering. These probabilistic algorithms aim to find global optimal solutions of an optimization problem by searching a large state space, and sometimes are content with sampling low-energy configurations.

The use of Houdayer moves combined with parallel tempering has been shown to speed-up convergence to minima, as it acts as a form of a tunnelling effect by helping to explore solutions with similar levels of energy as the current ones. As indicated hereinabove, the success of the Houdayer move is limited by the connectivity of the graph at hand. This limitation can advantageously be alleviated by performing a ReduCon Houdayer move when the graph becomes too connected. Problems such as Knapsack or MAX 2-SAT can benefit from the ReduCon Houdayer move, making it much easier to rapidly reach low-energy solutions when the ReduCon Houdayer move is combined with usual Monte-Carlo methods. Note also that ReduCon can be used in combination with other versions of the Houdayer move such as the generalization presented in “The Houdayer Algorithm: Overview, Extensions, and Applications” (https://arxiv.org/pdf/2211.11556.pdf).

Another class of methods which the ReduCon Houdayer move can enhance is one termed “hybrid”. For such methods, the main Monte-Carlo procedure is performed on a non-binary formulation of the optimization problem, but the (ReduCon) Houdayer move is performed on the equivalent Ising/QUBO formulation in accordance with methods and systems of the present embodiments. There is thus a conversion taking place to go from the non-binary formulation to the binary one. This is done because it is sometimes much easier to perform an optimization algorithm (like simulated annealing or parallel tempering) on a formulation of the problem where variables can take up many different values rather than converting it to a complex Ising/QUBO formulation before performing the optimization in the Ising/QUBO formulation. The Ising/QUBO formulation is only used to enable the application of the (ReduCon) Houdayer move, giving once again the opportunity to find pairs of configurations at the same energy level.

An optimization procedure (like simulated annealing) in this context starts from some pair of configurations of the variables in the non-binary formulation. One step of the optimization algorithm is performed in which a new pair of configurations is found. The pair of configurations is then converted to a corresponding one in the QUBO formulation. The Houdayer move (or the ReduCon Houdayer move if the underlying graph is too connected) is next performed to obtain a new pair of configurations at the same total energy level. The pair of configurations is then converted back to the corresponding pair in the non-binary formulation. Finally, the procedure goes back to performing a step of the optimization algorithm and this process is repeated unless some stopping criterion is met.

Another application where the methods and systems in accordance with the present embodiments provides beneficial efficiencies as discussed in “The Houdayer Algorithm: Overview, Extensions, and Applications” (https://arxiv.org/pdf/2211.11556.pdf) is improving sampling of low-energy configurations. It is known that use of the Houdayer improves the sampling of low-energy configurations, especially where ground states are the ultimate aim. Some conventional strategies make use of the principle that, since the Houdayer move preserves the total energy of the pair of configurations, it must be either that one of the two configurations decreases in energy or that both stay at the same energy level. In general, for this application the methods and systems in accordance with the present embodiments would start with generating some low-energy configurations through typical heuristic methods like simulated annealing to form a set P. The configurations in P are then paired, allowing one to use Houdayer moves to potentially generate more pairs at the same total energy level. If the Houdayer moves are successful, new configurations with lower energy levels are reached and these new configurations are stored in the set P with the previous configurations. As the set P has been augmented with the new configurations with lower energy levels, the configurations in P are paired and more pairs are generates using the Houdayer move unless some stopping criterion is met. The stopping criteria may include a predetermined number of iterations or a determination that no new pairs are being generated at the same total energy level. These steps can easily be customized and improved aimed at focusing the generation towards configurations with lower energy, yielding for example genetic algorithms when a selection process is added.

More generally, any algorithm that makes use of the Houdayer move benefits from the ReduCon methods and systems in accordance with the present embodiments as the ReduCon methods and systems offer access to more successful Houdayer moves by reducing connectivity of the original formulation. Additional examples of uses of the Houdayer move which can benefit from the ReduCon methods and systems in accordance with the present embodiments include genetic algorithms making use of the Houdayer during the reproduction step and multi-objective optimization such as those where one is interested in finding Pareto optimal solutions, or more generally, the Pareto front (i.e., the set of Pareto optimal outcomes). In regards to multi-objective optimization interested in finding Pareto optimal solutions, if all objectives are themselves in Ising/QUBO, one can combine them into a bigger Ising/QUBO problem by using a technique called linear scalarization. For example, if there are m objective functions [symbol] (x), . . . , [symbol] (x) to be optimized, one can consider the new unique objective function Q(x)=Σᵢ₌₁^{m}wᵢQᵢ(x), where wᵢ>0∀i∈{1, . . . , m}. This can then be solved with the help of Houdayer moves, and thus ReduCon Houdayer moves when beneficial. In particular, it can be shown that the solutions to the linear scalarization problem [symbol] (x) is on the Pareto front, no matter the choice of weights. This means that if one is able to get a few solutions to the linear scalarization problem, one could use them together with the ReduCon Houdayer move in accordance with the methods and systems of the present embodiments to potentially generate many more solutions at the Pareto front.

Those skilled in the art will realize that there are a number of practical applications which can benefit from the ReduCon methods and systems in accordance with the present embodiments. For example, applications in logistics and scheduling can benefit from the ReduCon methods and systems in accordance with the present embodiments. These include logistic planning for cargo shipping, car manufacturing, job shop scheduling or traffic flow optimization. As a shipping example, packages are usually shipped through cargo trucks or planes. While every package has a certain weight and dimension, a cargo vehicle has a fixed capacity and weight limitation. The cost to the shipper of sending a package usually does not depend on the weight, since dispatchers get paid on a contract. The dispatchers, therefore, try to maximize their profit by packing efficiently and shipping the maximum weight in a fixed volume. Improved solutions to this profit optimization problem can advantageously be obtained by the ReduCon methods and systems in accordance with the present embodiments. Another logistics application for the ReduCon methods and systems in accordance with the present embodiments is optimizing solutions for vehicle routing. The vehicle routing problem is an important combinatorial optimization problem in which the goal is to find an optimal set of routes for a fleet of vehicles that deliver goods from an origin (depot) to a set of destinations (customers).

In the area of biology and chemistry, protein folding and molecular similarity problems can benefit from the ReduCon methods and systems in accordance with the present embodiments. Finance, particularly financial investing, can benefit from the ReduCon methods and systems in accordance with the present embodiments. Examples include investment portfolio optimization and portfolio allocation.

Also, there are several software services, products or toolkits where ReduCon could potentially be added or built in to enhance the applicability and performance of the products and provide improved optimization capabilities. For example, Microsoft Azure QIO is a service offering CPU and FPGA implementations of algorithms such as simulated annealing, parallel tempering, population annealing, tabu search, quantum Monte Carlo, and substochastic Monte Carlo. As many of these algorithms are likely to incorporate Houdayer moves, the ReduCon methods and systems in accordance with the present embodiments could improve the algorithms capabilities. A similar Microsoft offering is 1 Qbit (1 Qloud).

Matlab Global Optimization Toolbox (not to be confused with the Matlab Optimization Toolbox), Google OR-Tools, Microsoft Excel, Anylogistix supply chain and logistics software, and Gurobi appear to target similar problems and, even if not presently capable of benefiting from ReduCon methods and systems, may evolve into products that will require the optimization problem solving benefits and advantages provide by the ReduCon methods and systems in accordance with the present embodiments.

To test the advantages of using the ReduCon methods and systems in accordance with the present embodiments to address such problems, a 0-1 Knapsack problem is studied. Given n items numbered 1 to n, each with associated value vi and weight wᵢ, the test is to find which subset of the items to pack into a knapsack with weight capacity W such that the value of the knapsack is maximized. The 0-1 Knapsack problem can be formulated as a linear program as seen in Equation (17):

$$minimize - {\sum }_{i = 1}^{n} {v}_{i} {x}_{i} \qquad ( 17 )$$

$$subject to {\sum }_{i = 1}^{n} {w}_{i} {x}_{i} \leq W$$

By adding slack variables, one can easily turn the inequality constraint into an equality constraint, thus recovering a problem of the form of Equation (1) or the form of Equations (6) and (7). In particular, the linear constraint creates a full-connectivity in the underlying graph, which is a perfect use-case for the ReduCon methods and systems in accordance with the present embodiments.

By comparing different variants of the parallel tempering procedure to understand the benefits of the ReduCon methods and systems in accordance with the present embodiments, the Knapsack problem can more thoroughly be investigated and the methods and systems in accordance with the present embodiments can methodically be tested. The variants are changes in the Monte-Carlo moves used within parallel tempering to explore the state space. The Monte-Carlo moves used are single-flips combined with Houdayer moves, and single-flips combined with ReduCon Houdayer moves, in order to understand how ReduCon is able to enhance the results obtained by only using the Houdayer move. Moreover, the parallel tempering algorithm is run for 2500 iterations using 30 temperatures spaced geometrically between 0.001 and 21, where at each temperature two configurations are simulated. The algorithm works as follows: at every iteration, the two configurations at each temperature are first altered by a single-flip independently. Then, for each temperature, the Houdayer (or ReduCon Houdayer) move is performed on the pair at that temperature. Also, only the energy of the two configurations at the lowest temperature are kept track of.

Ten instances with n=100 items were chosen with weights wᵢ chosen uniformly at random in the set {1, . . . , 10}, values given by νᵢ=i, and weight capacity given by W=20. For each instance, the optimal solution was computed via dynamic programming (since the problem size is small) in order to compare our results. Experiments were performed as described hereafter, where for each instance, the parallel tempering scheme described hereinabove was used.

Since the optimum value is known in this example, the relative error for each run was computed at each iteration to see its evolution, noting that given some target value ν and its approximation \tilde{ν}, the relative error is defined as

$$\vert \frac{v - \tilde{v}}{v} \vert .$$

The mean and standard deviation of the relative errors computed over the 10 instances were then plotted in order to visualize the evolution of the average relative error. Results of the multiple aggregated parallel tempering procedures for different types of Monte-Carlo moves are shown in a graph 1300 in FIG. 13 where the relative error for optimal solutions computed by Houdayer moves 1310 and the relative error for optimal solutions computed by the ReduCon Houdayer move 1320 are plotted in the graph 1300. For each move, the mean relative error together with its standard deviation was plotted as a function of the iteration number.

Looking at the graph 1300, some interesting behaviours can be observed. As expected, since the Knapsack has an underlying fully-connected graph, the performance of the single-flips with the Houdayer move is the worst. It is in fact the same as if no Houdayer move was used at all. The most striking result is the outcome of the ReduCon Houdayer move which was able to reduce the relative error by orders of magnitude and even reach the optimal solution, showing the benefit of the ReduCon methods and systems in accordance with the present embodiments.

While the utility of the ReduCon strategy in the context of Houdayer Monte-Carlo moves has been discussed, at its core the ReduCon methods and systems in accordance with the present embodiments is a scheme which allows one to reduce the density of certain types of interaction in a system by introducing more variables (i.e., “register” variables). Thus, it is clear that the ReduCon methods and systems in accordance with the present embodiments can be applied in other situations where the ultimate objective is not to improve the success of Houdayer moves.

Specifically, the ReduCon methods and systems in accordance with the present embodiments may be applied when a high graph density is potentially induced by an optimization constraint, such as that of Equation (6). Optimization problems of this nature are very common (e.g., the Knapsack problem discussed above), and in recent years there has been much interest in solving them in the Ising/QUBO formulation. At the same time, there has emerged a generation of specialized CMOS classical hardware designed specifically for running highly parallel implementations of physics-based algorithms, such as simulated annealing and parallel tempering. Optics-based platforms may also be used to solve complex combinatorial optimization problems, leveraging the natural physical behaviour of the system to find its lowest energy state.

In constructing such hardware, it may be challenging to fully interconnect many thousands of nodes or qubits, resulting in limitations to the scalability of such devices to larger sizes. For the classes of problem where ReduCon may be applied, the ReduCon methods and systems in accordance with the present embodiments could be used to design specialized hardware with a lower density of connectivity nodes, potentially overcoming scalability issues. Since constrained optimization problems similar to the Knapsack problem are of significant economic value, there may be a compelling case for constructing hardware designed specifically to solve them. Thus, ReduCon systems in accordance with the present embodiments implemented in hardware products designed specifically for optimization resolution, and even being designed for specific optimization problem(s), can provide advantages and benefits as discussed herein.

Thus, it can be seen that the present embodiments provide systems and methods for a novel procedure designed to reduce the connectivity of graphs underlying Ising/QUBO problems. In doing so, new avenues are opened to use the Houdayer cluster Monte-Carlo algorithm, enabling one to reach lower energy levels in settings where it would previously fail. In accordance with the present embodiments, systems and methods are provided which enable improved reduction in the density of certain types of interaction in a system by introducing more variables (i.e., “register” variables), those variables, in some instances, forming barriers (i.e., “register barriers”) to allow connected components to not join together and thereby reducing connectivity. Since the ReduCon methods and systems in accordance with the present embodiments describe a relatively general procedure, there are multiple choices to be made when employing them. In particular, schemes in accordance with the present embodiments yield groupings of variables which empirically increase the chance of success of the Houdayer move.

Overall, the methods and systems in accordance with the present embodiments go hand in hand with the Houdayer move and, thus, can be used in any application where the Houdayer move is used, such as the behaviour of parallel tempering on a specific Knapsack instance, an optimization problem where the usual Houdayer move is inefficient. In addition, the ReduCon methods and systems in accordance with the present embodiments allows a variety of complex problems to enjoy the benefits of the Houdayer move, resulting in a better optimization.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

1. A computer-implemented method for transformation of an optimization problem to facilitate its resolution, the method comprising:
casting the optimization problem into a quadratic unconstrained binary model; and
transforming the optimization problem into an optimization problem having the quadratic unconstrained binary model with reduced connectivity, wherein transforming the optimization problem comprises:
partitioning decision variables in the quadratic unconstrained binary model into two or more groups, each of the two or more groups comprising at least one decision variable node; and
introducing a register variable node between adjacent pairs of the at least one decision variable node in the two or more groups to hold partial values of a sum in a linear constraint to form the optimization problem with reduced connectivity.

2. The method in accordance with claim 1, wherein transforming the optimization problem comprises forming a graphical visualization transformation of the quadratic unconstrained binary model before the partitioning step.

3. The method in accordance with claim 2, wherein the graphical visualization transformation comprises a graph network having nodes and edges.

4. The method in accordance with claim 3, wherein the nodes are qubits.

5. The method in accordance with claim 1, wherein casting the optimization problem comprises casting the optimization problem in a form of a quadratic unconstrained binary model by turning linear equality constraints into quadratic penalties of the quadratic unconstrained binary model.

6. The method in accordance with claim 1, wherein introducing a register node comprises introducing two or more register variable nodes to form the optimization problem with reduced connectivity, each of the two or more register variable nodes introduced between adjacent pairs of the at least one decision variable node in the two or more groups to hold the partial values of a sum in a linear constraint, and wherein transforming the optimization problem comprises forming a register variable edge between adjacent pairs of the introduced two or more register variable nodes.

7. The method in accordance with claim 1, wherein each of the one or more groups are different from one another.

8. The method in accordance with claim 1, wherein each register variable node acts as a buffer during an overlap process.

9. The method in accordance with claim 1, wherein the quadratic unconstrained binary model comprises a quadratic unconstrained binary optimization (QUBO) model or an Ising model based on a range of variables in the quadratic unconstrained binary model.

10. The method in accordance with claim 1, wherein at least one register variable node comprises a plurality of register variables.

11. The method in accordance with claim 1, wherein the partitioned decision variables are interconnected with one another.

12. The method in accordance with claim 1, further comprising removing a last decision variable node from the configuration of more than one decision variable nodes in the reduced connectivity optimization problem.

13. The method in accordance with claim 1, further comprising performing a Houdayer move on the reduced connectivity optimization problem thus resulting in a new optimization problem, the method further comprising casting the new optimization problem into a new quadratic unconstrained binary model and transforming the new quadratic unconstrained binary model by the steps of partitioning decision variables and introducing a register variable.

14. The method in accordance with claim 13, wherein performing the Houdayer move on the reduced connectivity optimization problem comprises:
converting the two or more groups comprising the at least one decision variable node in an underlying graph of the reduced connectivity optimization problem to a corresponding two or more groups comprising at least one decision variable node in an underlying graph of the new optimization problem;
performing the Houdayer move on the underlying graph of the new optimization problem to generate a new set of two or more groups comprising at least one decision variable node; and
converting the new set of two or more groups comprising at least one decision variable nodes to a corresponding one or more groups comprising at least one decision variable node in the underlying graph of the reduced connectivity optimization problem.

15. The method in accordance with claim 1, wherein the step of partitioning decision variables comprises partitioning the decision variables in the quadratic unconstrained binary model into one or more groups in a quantum system.

16. A system for transformation of an optimization problem to facilitate resolution of the optimization problem, the system comprising:
one or more processors; and
storage means connected to the one or more processors, the storage means comprising instructions for controlling the one or more processors to:
cast the optimization problem into a quadratic unconstrained binary model; and
transform the optimization problem into an optimization problem having the quadratic unconstrained binary model with reduced connectivity, wherein transforming the optimization problem comprises instructions to control the processor to:
partition decision variables in the quadratic unconstrained binary model into two or more groups, each of the two or more groups comprising at least one decision variable node; and
introduce a register variable node between adjacent pairs of the at least one decision variable node in the two or more groups to hold partial values of a sum in a linear constraint to form the optimization problem with reduced connectivity.

17. (canceled)

18. (canceled)

19. (canceled)

20. The system in accordance with claim 16, wherein the instructions to control the one or more processors to cast the optimization problem comprise instructions to control the one or more processors to cast the optimization problem in a form of a quadratic unconstrained binary model by turning linear equality constraints into quadratic penalties of the quadratic unconstrained binary model.

21. The system in accordance with claim 16, wherein the instructions to control the one or more processors to introduce the register variable node comprise instructions to control the one or more processors to introduce more than one register variable node, each of the more than one register variable node introduced between different adjacent pairs of the at least one decision variable node in the two or more partitioned groups, and wherein transforming the optimization problem comprises forming a register variable edge between adjacent pairs of the more than one register variable nodes introduced.

22. (canceled)

23. (canceled)

24. The system in accordance with claim 16, wherein the quadratic unconstrained binary model comprises a quadratic unconstrained binary optimization (QUBO) model or an Ising model based on a range of variables in the quadratic unconstrained binary model.

25. (canceled)

26. (canceled)

27. The system in accordance with claim 16, wherein the instructions to control the one or more processors further comprise instructions to remove a last decision variable node from the configuration of more than one decision variable nodes in the reduced connectivity optimization problem.

28. (canceled)

29. (canceled)

30. (canceled)
